(19) United States
(12) Patent Application Publication
(10) Pub. No.: US 2009/0042673 A1
(43) Pub. Date: Feb. 12, 2009

(54) BASKETBALL GAME, PACKAGE, AND METHOD

(76) Inventor: Steven Scott Radice, Oak Lawn, IL (US)

Correspondence Address: VEDDER PRICE P.C., 222 N. LASALLE STREET, CHICAGO, IL, 60601, US

(21) Appl. No.: 12/186,422

(22) Filed: Aug. 5, 2008

Related U.S. Application Data
(63) Continuation-in-part of application No. 11/835,103, filed on Aug. 7, 2007.

(51) Int. Cl. A63B 71/00; A63B 69/00; G09B 19/22

(52) U.S. Cl. 473/447; 473/479; 473/472; 434/248; 206/579

(57) ABSTRACT

The use of spot locations that are freely movable with respect to one another and that include different uses for each side is an improvement over the prior art. A basketball game includes at least one ball, a playing surface, a support structure, a backboard, a hoop, and a plurality of spot locations, and may further include a timekeeping device. Each spot location has a first surface which may include a first plurality of raised dimples arranged thereon and a second surface, in opposition to the first surface, which may include a second plurality of raised dimples arranged thereon. The first surface has a first marking thereon and the second surface has a second marking thereon. On at least one spot location, the first marking differs from the second marking. Additionally, a basketball game package and method of playing a basketball game utilize aspects of the basketball game.

### CROSS-REFERENCE TO RELATED APPLICATIONS

This application claims priority from and the benefit of co-pending application Ser. No. 11/835,103, filed Aug. 7, 2007, entitled BASKETBALL GAME, PACKAGE, AND METHOD, which is incorporated herein by reference, as a continuation-in-part thereof.

### FIELD OF THE INVENTION

The present disclosure relates generally to the game of basketball, and in particular, to a new and improved basketball game, package, and method of playing that are based on new rules for different skill levels of players.

### BACKGROUND OF THE INVENTION

The game of basketball and its known rules were invented by Dr. James Naismith of Ontario, Canada, in 1891. Despite skepticism as to the eventual success of the game, basketball developed into one of the most popular competitive and recreational sports in the world. The game includes a hoop and net assembly mounted on a backboard through which a ball is thrown from a playing surface for the purpose of scoring points. The ball may be thrown directly through the hoop, or in the alternative, may be banked off of the backboard in such a way as to cause it to go through the hoop after a bounce. Among the exciting elements of basketball is the time pressure that can be introduced in competitive situations, including those involving multiple players and those involving a single player. The playing experience may be enhanced by trying to throw the ball through the hoop, blocking an opponent from scoring, or defeating an opponent within a certain amount of time. Advantages of playing basketball include development of hand-eye coordination and the ability to play either indoors or outdoors.

Several new basketball games, each having a different set of rules, have been introduced, some of which include the use of spot locations during play. Spot locations denote locations from which players must attempt to shoot the ball into the hoop. Spot locations may also be used in other ways.

One way involves the use of indicators at a fixed location. The indicators may be either independent structures permanently attached to the playing surface or may be marked directly thereon. These indicators, however, cannot be rearranged on the playing surface to allow for different and evolving sets of rules. These indicators are also inherently inefficient in that only one side of each indicator may be utilized, since they are affixed to the playing surface, thus further limiting the number of different rules that may be employed. Fixed indicators requires a greater number of units to facilitate a particular number of different rules.

Movable shooting indicators are used. However, the individual spot locations are interconnected and must all be moved at once in the same direction or along a predetermined path, thus severely limiting the number of different rules that may be employed. Other known arrangements are disadvantageous in that they do not include different uses of opposite sides of a spot location under different rules and therefore fail to provide the most efficient use of the spot location. What is needed is a new and more efficient game capable of utilizing indicators in an optimal way.

### SUMMARY OF THE INVENTION

The use of spot locations that are freely movable with respect to one another and that include different uses for each side of the spot locations, thereby increasing the efficient use of the spot locations, and the use of more comprehensive and creative sets of rules with such spot locations, is an improvement over the prior art. A basketball game includes at least one ball, a playing surface, a support structure, a backboard, a hoop, and a plurality of spot locations, and may further include a timekeeping device. Each spot location has a first surface which may include a first plurality of raised dimples arranged thereon and a second surface, in opposition to the first surface, which may include a second plurality of raised dimples arranged thereon. The first surface has a first marking thereon and the second surface has a second marking thereon. On at least one spot location, the first marking differs from the second marking. The different markings and the mobility of the spot locations relative to one another allow for a greater number of different placements of the spot locations on the playing surface for easy changes between different configurations and a greater number of different, creative sets of rules to be employed using fewer spot locations. Additionally, what is disclosed is a basketball game, package, and method of playing a basketball game that utilize aspects of the basketball game.

### BRIEF DESCRIPTION OF THE DRAWINGS

FIG. 1 is an illustration of a basketball game according to a first embodiment of the present disclosure.

FIG. 2 is an illustration of the first surface of a spot location showing a plurality of raised dimples arranged thereon as used in the basketball game shown in FIG. 1.

FIG. 3 is an illustration of the second surface of a spot location showing a plurality of raised dimples arranged thereon as used in the basketball game shown in FIG. 1.

FIG. 4 is an illustration of the first surface of a spot location as used in the basketball game shown in FIG. 1.

FIG. 5 is an illustration of the second surface of a spot location as used in the basketball game shown in FIG. 1.

FIG. 6 is a side view of the first surface of a spot location as used in the basketball game shown in FIG. 1.

FIG. 7 is an illustration of the basketball game of FIG. 1 with two spot locations, including a view of the first surface and second surface of one spot location, relative to a playing surface, according to another embodiment of the present disclosure.

FIG. 8 is an illustration of a basketball game package in accordance with one aspect of the present disclosure.

FIG. 9 is an illustration of a method of playing a basketball game in accordance with another aspect of the present disclosure.

### DETAILED DESCRIPTION

The present disclosure is not meant to be limited to the particular details as depicted, and other modifications and applications may be contemplated. Further changes may be made in the above-described details without departing from the true spirit and scope of the invention herein involved. It is intended, therefore, that the subject matter in the above depiction should be interpreted as illustrative, not in a limiting sense.

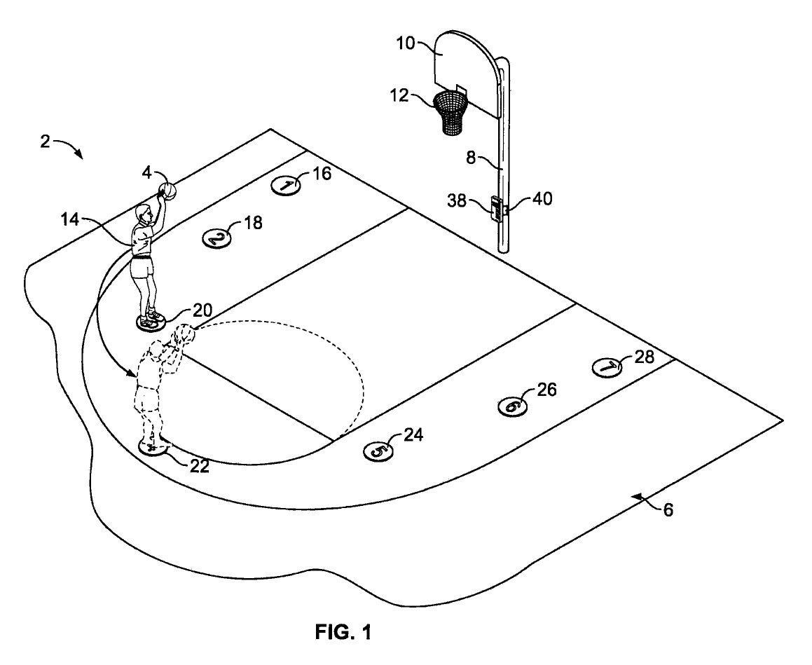

FIG. 1 illustrates a basketball game 2 in accordance with one aspect of the present disclosure. The basketball game 2 includes at least one ball 4, a playing surface 6, a support structure 8, a backboard 10, a hoop 12 from which a net may be suspended, at least one player 14, and a plurality of spot locations 16-28. The at least one ball 4 may be any suitable type of ball that may be received within the hoop 12, but in a preferred embodiment, the at least one ball 4 is a basketball. The playing surface 6 may be any suitable type of surface, including but not limited to concrete, asphalt, stone, clay, and hardwood (such as when the basketball game 2 is played indoors). The support structure 8 may be any suitable type of structure, including but not limited to a metal or wood pole, a column, a system of wall or ceiling mounts, and a roof or exterior wall of a house or other building. The backboard 10 may be any suitable transmissive or opaque structure off of which the at least one ball 4 may be banked or bounced, including but not limited to plastic, metal, plywood, and structural foam or may be configured as part of the support structure 8. The hoop 12 may be made from any suitable material, including but not limited to steel, wood, and plastic.

In one embodiment, the support structure 8 is mounted on and extends above the playing surface 6. In another embodiment, the support structure 8 is mounted adjacent to the playing surface 6, that is, outside a series of playing surface boundaries and extending above the playing surface 6. In still another embodiment, the support structure 8 is mounted above the playing surface 6, such as on a wall, ceiling, or other structure extending above the playing surface 6. In one embodiment, the backboard 10 is mounted on the support structure 8. The hoop 12 is mounted as shown in FIG. 1 on the backboard 10 and oriented to receive the at least one ball 4 from the at least one player 14 on the playing surface 6. The hoop 12 may be oriented in any suitable direction in which the hoop 12 is capable of receiving the at least one ball 4, but in a preferred embodiment, the hoop 12 is mounted such that the plane of the hoop 12 is substantially parallel to the plane of the playing surface 6.

During play of the basketball game 2, each of the spot locations 16-28 is disposed on the playing surface 6 by a player. Each of the spot locations 16-28 designates a location on the playing surface 6 from which the at least one player 14 may attempt to shoot the at least one ball 4 into the hoop 12. Although FIG. 1 illustrates seven spot locations 16-28, this number is by way of example only, and it is to be understood that any other number of spot locations may be used.

In a preferred embodiment, the spot locations 16-28 are not connected to one another and may be disposed on the playing surface in any position or orientation relative to one another. However, it is understood that the present disclosure also contemplates the arrangement of the spot locations 16-28 in any fixed or adjustable position relative to one another by way of interconnection of the spot locations 16-28 using, for example, flexible straps or any other suitable means of interconnection.

Each spot location 16-28 may be made from any suitable material on which the at least one player 14 can stand while attempting to shoot the at least one ball 4 into the hoop 12. In a preferred embodiment, the spot locations 16-28 are made from a PVC (polyvinyl chloride) and vinyl material. PVC and vinyl are especially desirable in view of their light weight, durability, weather resistance, and skid resistance, thereby allowing the basketball game 2 to be highly competitive and fast-paced without interruptions caused by weathering conditions or inadvertent movement of the spot locations 16-28. It is understood that the present disclosure also contemplates the use of other materials for the spot locations 16-28, including but not limited to rubber, plastic, foam, nitrile, wood, metal, and neoprene, any of which may offer a surface finish resistant to skids during play.

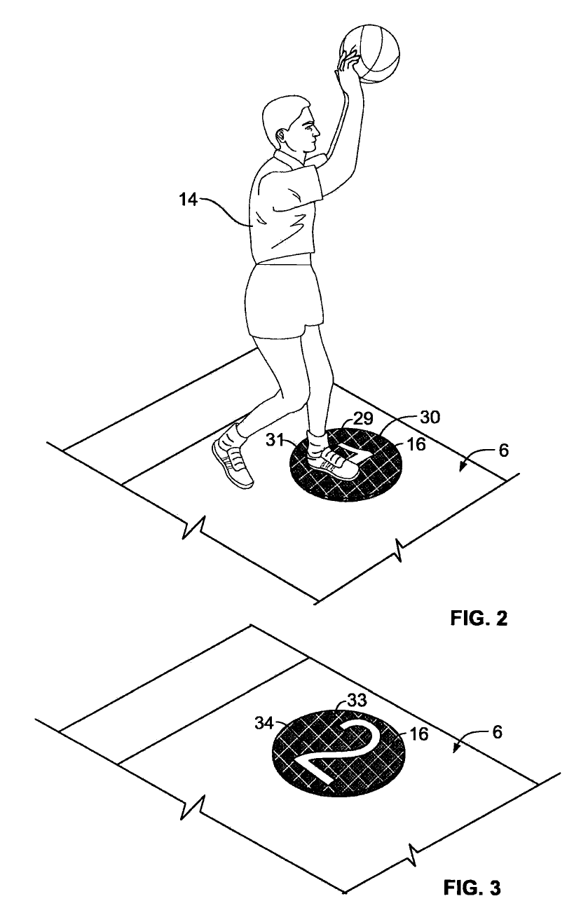

Further, in one embodiment, each spot location 16-28 may include a first surface 30 with a first plurality of raised dimples 29 arranged thereon, as shown for spot location 16 in FIG. 2. The first plurality of raised dimples 29 may be arranged, for example, in a suitable pattern, such as but not limited to the arrangement of the first plurality of raised dimples 29 in rows and columns covering the first surface 30 of each spot location 16-28. The first plurality of raised dimples 29 may be made from, for example, a PVC and vinyl material, blown polypropylene, or any suitable material which provides further durability, weather resistance, and skid resistance between, for example, a foot 31 of the at least one player 14 and the first surface 30 of each spot location 16-28.

In one embodiment, each spot location may further include a second surface 34 with a second plurality of raised dimples 33 arranged thereon, as shown for spot location 16 in FIG. 3. The second plurality of raised dimples 33 may be arranged, for example, in a suitable pattern, such as but not limited to the arrangement of the second plurality of raised dimples 33 in rows and columns covering the second surface 34 of each spot location 16-28. The second plurality of raised dimples 33 may be made from, for example, a PVC and vinyl material, blown polypropylene, or any suitable material which provides further durability, weather resistance, and skid resistance between, for example, the playing surface 6 and the second surface 34 of each spot location 16-28 when the second surface 34 of each spot location 16-28 is in contact with the playing surface 6. In this embodiment, when the playing surface 6 is dry, rough, or otherwise configured to prevent skidding between the playing surface 6 and the second surface 34 of each spot location 16-28, the second plurality of raised dimples 33 may be omitted.

In a preferred embodiment, each spot location 16-28 is of a substantially circular shape and has a diameter of approximately eighteen inches. However, it is understood that the present disclosure also contemplates the use of substantially circular spot locations with diameters greater or less than eighteen inches, including such diameters as may be too small for the at least one player 14 to be able to place both feet completely within the boundaries of each spot location 16-28. It is further understood that the present disclosure contemplates the use of any other shape of spot locations, including but not limited to rectangles, squares, and triangles.

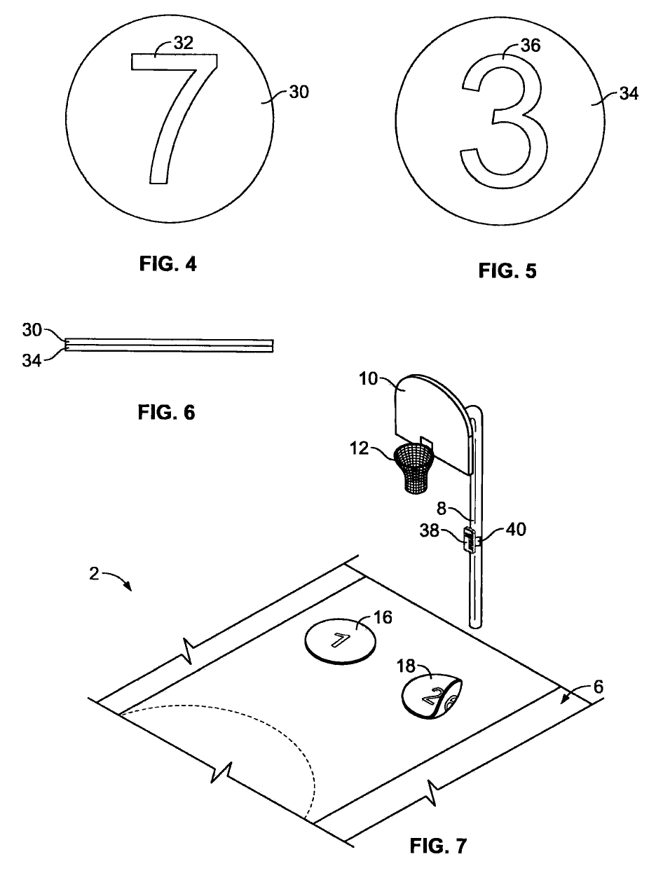

The first surface 30 of each spot location 16-28 has a first marking 32 thereon as shown in FIG. 4, and the second surface 34 of each spot location 16-28 has a second marking 36 thereon as shown in FIG. 5. In a preferred embodiment, the first marking 32 and the second marking 36 include numbers. However, it is understood that the first marking 32 and second marking 36 may be any suitable marking, including but not limited to letters, Roman numerals, points, lines, shapes, symbols, logos, and any combination of these examples. What is also contemplated is the use of markings to promote the game to advertisers who may wish to market the game as a method of advertising. Although spot locations has been illustrated in FIGS. 4-5 having a first marking indicating the number 7 and a second marking indicating the number 3, any suitable markings may be used, including any suitable numbers, as discussed in greater detail below.

As best seen in FIG. 6, for each spot location 16-28, the first surface 30 is in opposition to the second surface 34. Furthermore, as shown in FIG. 7, for at least one spot location 16-28 of the plurality of spot locations, the first marking 32 is different from the second marking 36.

In a preferred embodiment, the first marking 32 on the first surface 30 includes a number ranging from 1 to X, where X is equal to the total number of spot locations 16-28. By way of example, if the plurality of spot locations includes seven spot locations 16-28, X would equal 7 and the first marking 32 of each spot location 16-28 would include the series of numbers from 1 to 7. A number of different sets of rules may be used in conjunction with the plurality of spot locations 16-28 each having the first surface 30 visible from above the playing surface 6, several of which rules are described in detail hereinafter.

Further, in a preferred embodiment, the second marking 36 includes a number ranging from 1 to Y, where Y is a maximum point level used for scoring. That is, Y is a maximum point level that may be used in accordance with various rules of the basketball game 2 which assign different point levels for different spot locations. For each spot location 16-28, the second marking 36 signifies a point level of the spot location. By way of example, if the basketball game 2 includes four different point levels, Y would equal 4 and the second marking 36 of each spot location 16-28 would include a number from 1 to 4 to designate a point level of each respective spot location. For example, two of the spot locations 16 and 18 may include the number 1 designating a point level of 1, while another two of the spot locations 20 and 22 may include the number 2 designating a point level of 2, while still another two of the spot locations 24 and 26 may include the number 3 designating a point level of 3, and yet another single spot location 28 may include the number 4 designating a point level of 4. A number of different rules may be used in conjunction with the plurality of spot locations 16-28, each having the second surface 34 visible from above the playing surface 6, several of which rules are described in detail hereinafter.

As is recognized by one having ordinary skill in the art, numerous rules may be used in accordance with the above-described basketball game 2 to provide varied playing experiences, including rules for both one player and multiple players. Some such rules are more competitive in nature than others and require keeping count of elapsed time and/or remaining time.

Referring to FIG. 1, the basketball game 2 may further include a timekeeping device 38. The timekeeping device 38 may be any suitable device for keeping count of elapsed time and/or remaining time, either separately for each of the at least one player 14, or collectively with respect to the basketball game 2. For example, the timekeeping device 38 may be a clock, a stopwatch, a timer, a digital or analog watch, or an hourglass.

The timekeeping device 38 includes a supporting means 40 for attaching the timekeeping device 38 to the support structure 8 or to any other suitable object for display in the in the playing surface 6. In a preferred embodiment, the supporting means 40 includes a magnetic clip, but it is understood that the supporting means 40 may include any other suitable material or object capable of attaching the timekeeping device 38 to the support structure 8, including but not limited to an adhesive, one or more screws or nails, a clip, or a latch.

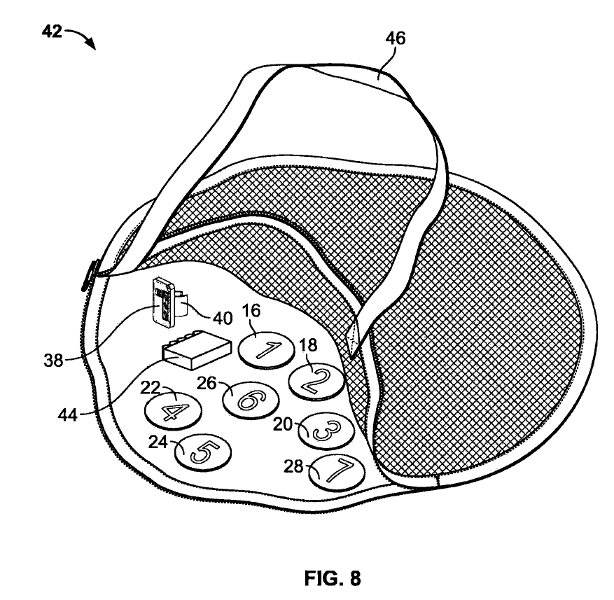

Referring to FIG. 8, the present disclosure provides for a basketball game package 42. The basketball game package 42 may be used in conjunction with a basketball game such as the above-described basketball game 2. The basketball game package 42 may be any suitable type of container, including but not limited to a pouch, a plastic bag, a duffel bag, a backpack, a briefcase, and a box such as a cardboard box. The basketball game package 42 includes an instruction source 44 and a plurality of spot locations, which may be the plurality of spot locations 16-28 described above. The basketball game package 42 may further include a timekeeping device, which may be the timekeeping device 38 described above.

The instruction source 44 includes rules that may be used in playing the basketball game 2 and may be in any suitable form capable of conveying information regarding these rules. By way of example, the instruction source 44 may be one or more sheets of paper, a booklet, an audiotape, a compact disc, or any other medium on which information may be stored and from which information may be accessed.

In a preferred embodiment, the basketball game package 42 includes a carrying component 46. The carrying component 46 may be any suitable component that allows one or more persons to carry the basketball game package 42 from one place to another, including but not limited to a shoulder strap, one or more handles, a string, and a cord.

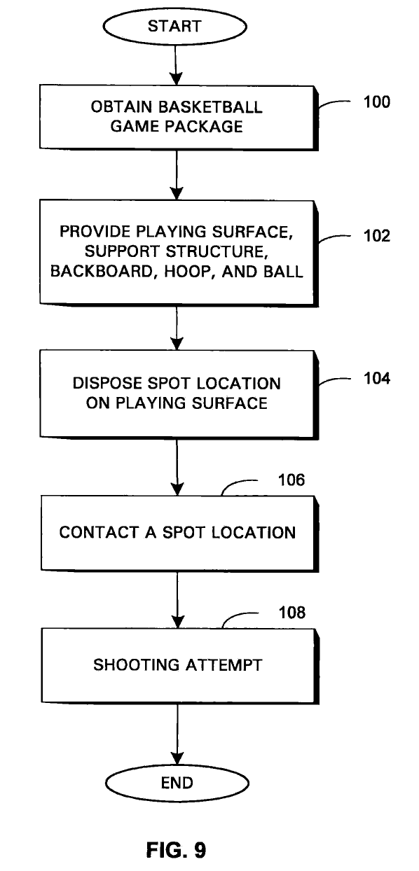

Referring to FIG. 9, the present disclosure also provides a method of playing a basketball game, such as the basketball game 2. As shown in block 100, the method includes obtaining a basketball game package. The basketball game package may be the basketball game package 42 described above as having an instruction source and a plurality of spot locations. The instruction source may be the instruction source 44 described above, and the plurality of spot locations may be the plurality of spot locations 16-28 described above.

As shown in block 102, the method further includes providing a playing surface, a support structure, a backboard, a hoop, and a ball. The playing surface, the support structure, the backboard, the hoop, and the ball may be, respectively, the playing surface 6, the support structure 8, the backboard 10, the hoop 12, and a ball of the at least one ball 4, as described above.

As shown in block 104, the method further includes disposing the plurality of spot locations 16-28 on the playing surface 6. As with the basketball game 2 described above, the plurality of spot locations 16-28 may be disposed on the playing surface 6 without any connection to each other or interconnected with each other.

As shown in block 106, the method further includes contacting a spot location of the plurality of spot locations 16-28. For purposes of this disclosure, a player, such as the at least one player 14 of the basketball game 2, is considered to be in contact with a spot location if the at least one player 14 is either standing at least partially on a spot location or is aloft from a jump that began while standing at least partially on a spot location. The particular spot location to be contacted may be determined in accordance with a set of rules of the basketball game 2 or randomly if the rules do not specify a particular spot location or no rules are in use.

As shown in block 108, the method further includes attempting to shoot the ball into the hoop 12 while contacting the spot location of block 106. The method is then complete. It will be understood, however, that the method may be repeated as desired to provide for continuous play of the basketball game 2. For example, a different player may repeat the method if the basketball game 2 involves multiple players.

Optionally, the method is performed further utilizing a timekeeping device, which may be the timekeeping device 38 as described above. The timekeeping device 38 includes a supporting means for attaching the timekeeping device 38 to the support structure 8. The supporting means may be the supporting means 40 described above.

The above method need not be performed in the order described. Rather, the present disclosure contemplates any sensible variation of arrangement. For example, block 102 (providing a playing surface, a support structure, a backboard, a hoop, and a ball) may be performed before block 100, obtaining a basketball game package.

In accordance with the present method, numerous sets of rules may be used to provide various playing experiences for one player and multiple players. Several exemplary sets of rules are described in detail below. It is understood that these sets of rules may be improvised, modified, or added to, all falling within the teaching of the present disclosure. Specific reference to certain games should not be construed as a limitation of the invention but merely to suggest its scope and versatility.

Several sets of rules are utilized in the situation where each spot location of the plurality of spot locations 16-28 is disposed on the playing surface 6 such that the first surface 30 of the spot location is substantially visible to a player on or near the playing surface 6. That is, a player standing on or near the playing surface 6 would be able to see substantially all of the first surface 30 and be substantially or completely unable to see the second surface 34 of the spot location. The basketball game 2 is played by at least one player 14. Each player makes at least one attempt to shoot the ball into the hoop 12 during a turn. Turns are taken in an alternating manner with respect to any other players of the at least one player 14.

The actual number of attempts made during a turn depends on the success or failure of each attempt and the rules in use. The player is in contact with one spot location of the plurality of spot locations 16-28 during each of the attempts to shoot the ball into the hoop 12. Upon a successful attempt to shoot the ball into the hoop 12, i.e., if the player succeeds in shooting the ball into the hoop 12, the player is permitted to advance to the next spot location of the plurality of spot locations 16-28 in accordance with a predetermined order of advancement, which is determined by the rules in use during the basketball game 2. Such player advancement may occur either during the turn or at a beginning of a next turn of the player. That is, depending upon the rules in use, the successful attempt to shoot the ball into the hoop 12 may terminate the turn with the player beginning the player's next turn in contact with the next spot location or the player may be permitted to continue the turn while in contact with the next spot location. Under such rules, the turn may therefore include a number of attempts made up of a number of successful attempts to shoot the ball into the hoop 12 that occur before a first unsuccessful attempt to shoot the ball into the hoop 12, and the first unsuccessful attempt to shoot the ball into the hoop 12. Stated differently, the turn includes both all successful attempts that occur before the first unsuccessful attempt and the first unsuccessful attempt, at which point the turn terminates.

Upon an unsuccessful attempt to shoot the ball into the hoop 12, i.e., upon a failure of the player to shoot the ball into the hoop 12, the player is not permitted to advance to the next spot location. Depending on the rules in use, the turn may either end or continue upon the unsuccessful attempt to shoot the ball into the hoop 12. For example, under some rules, the turn may include an allowable number of attempts to shoot the ball into the hoop 12. The allowable number of attempts may be a predetermined allowable number of attempts, regardless of whether each attempt is successful or unsuccessful. Alternately, the allowable number of attempts to shoot the ball into the hoop 12 may also be determined by a lesser of a predetermined maximum number of unsuccessful attempts and a total number of attempts required to successfully shoot the ball into the hoop 12. That is, the player continues shooting until he or she misses a number of shots equal to the predetermined maximum number of unsuccessful attempts, which in accordance with the rules may be any number 1 or higher, or until the player makes a successful attempt to shoot the ball into the hoop 12, whichever occurs first.

During play of the basketball game 2, each player attempts to successfully shoot the ball into the hoop 12 from all spot locations of the plurality of spot locations 16-28 while advancing through the plurality of spot locations 16-28 in the predetermined order of advancement before any other players successfully shoot the ball into the hoop 12 from all spot locations.

Some rules may further require the player to choose from among several options upon the occurrence of an unsuccessful attempt to shoot the ball into the hoop 12. Under such rules, the turn initially proceeds in a manner corresponding to any of the rules described above or any other suitable set of rules. If the player makes a successful attempt to shoot the ball into the hoop 12 which would terminate the turn under the corresponding rules, the turn terminates as it would under the corresponding rules. However, if the player makes an unsuccessful attempt to shoot the ball into the hoop 12 which would terminate the turn under the corresponding rules, the turn does not immediately terminate and the player is required to choose from among several options.

For example, under rules in which the turn includes a number of successful attempts to shoot the ball into the hoop 12 that occur before a first unsuccessful attempt to shoot the ball into the hoop 12 and the first unsuccessful attempt to shoot the ball into the hoop 12, the player must upon the first unsuccessful attempt elect one of several options as part of the turn.

As a further example, under rules in which the turn includes an allowable number of attempts to shoot the ball into the hoop 12, in the event the player reaches the allowable number of attempts upon making an unsuccessful attempt, the player must further elect one of several options as part of the turn in the event the player makes a number of unsuccessful attempts equal to the predetermined maximum number of unsuccessful attempts.

By way of example, the several options may be, in no particular order of preference or importance, (a) to terminate the turn without an additional attempt to shoot the ball into the hoop 12, and (b) to make an additional attempt to shoot the ball into the hoop 12 while in contact with the same spot location from which the player made the unsuccessful attempt to shoot the ball into the hoop 12 which would terminate the turn under the corresponding rules. If option (b) is chosen and the additional attempt is successful, the player is permitted to advance to the next spot location of the plurality of spot locations 16-28, either during the turn or at the beginning of the player's next turn. If option (b) is chosen and the additional attempt is unsuccessful, the player must begin the next turn in contact with a first spot location in the predetermined order of advancement and must retraverse the plurality of spot locations 16-28 in the predetermined order of advancement.

Still other rules are utilized in the situation where each spot location is disposed on the playing surface 6 such that the second surface 34 of the spot location is substantially visible to a player on or near the playing surface 6. That is, a player standing on or near the playing surface 6 would be able to see substantially all of the second surface 34 of the spot location. The basketball game 2 is played by at least one player, such as the at least one player 14.

Each spot location designates a point level. The point level is designated by the second marking 36 on the second surface 34 of the spot location. Spot locations designating high point levels are positioned in areas of the playing surface 6 having a greater degree of difficulty to shoot the ball into the hoop 12. For example, spot locations designating high point levels may be positioned nearer to or further from the hoop 12 to increase difficulty, they may be positioned at more challenging angles with respect to the hoop 12, or they may be positioned in accordance with some combination of these options.

Each player of the at least one player 14 attempts to accumulate more points than any other players after a predetermined number of attempts to shoot the ball into the hoop 12. The player is in contact with one spot location during each attempt. The predetermined number of attempts is in accordance with the rules. The rules may optionally provide for any suitable scheme of alternating turns among players, or each player may alternatively take all of the allotted predetermined number of attempts at once. The player's total points are determined by adding the point level of each spot location of the plurality of spot locations 16-28 from which the player makes a successful attempt to shoot the ball into the hoop 12.

Some rules may allow the player to choose which spot location to be in contact with during each attempt, with repetition of spot locations permissible and no requirement that all spot locations be contacted. Under other rules, the player must make the predetermined number of attempts to shoot the ball into the hoop by making one attempt from each spot location. This requirement may include the requirement of traversing the plurality of spot locations 16-28 in a predetermined order, the predetermined order including one shot from each spot location.

As will be apparent from the foregoing disclosure, the present disclosure provides a significantly improved basketball game, package, and method with the benefits of a number of different configurations of the spot locations, easy switching between such configurations, and a number of different, creative sets of rules to be employed, all using fewer spot locations.

Persons of ordinary skill in the art appreciate that although the teachings of the disclosure have been illustrated in connection with certain embodiments, there is no intent to limit the invention to such embodiments. On the contrary, this disclosure is intended to cover all modifications and embodiments falling fairly within the scope of the teachings of the disclosure.

What is claimed is:

1. A basketball game package comprising:
an instruction source; and
a plurality of spot locations,
wherein each spot location of the plurality of spot locations includes a first surface with a plurality of raised dimples arranged thereon.

2. The basketball game package of claim 1, wherein the first surface has a first marking thereon, wherein each spot location of the plurality of spot locations includes a second surface with a second marking thereon, wherein the second surface is in opposition to the first surface, and wherein at least one spot location has the first marking different from the second marking.

3. The basketball game package of claim 1, further comprising a timekeeping device, the timekeeping device including a supporting means for attaching the timekeeping device to a support structure.

4. The basketball game package of claim 1, wherein the first marking on the first surface of each spot location of the plurality of spot locations includes a number ranging from 1 to X, wherein X equals the number of spot locations, and wherein the second marking on the second surface of each spot location of the plurality of spot locations includes a number ranging from 1 to Y, wherein Y equals a maximum point level used for scoring.

5. The basketball game package of claim 1, wherein at least one spot location of the plurality of spot locations is made from a PVC and vinyl material.

6. A basketball game comprising:
at least one ball;
a playing surface;
a support structure mounted on, adjacent to, or above the playing surface;
a backboard mounted on the support structure;
a hoop mounted on the backboard and oriented to receive the at least one ball from at least one player on the playing surface; and
a plurality of spot locations;
wherein each spot location of the plurality of spot locations includes a first surface with a plurality of raised dimples arranged thereon.

7. The basketball game of claim 6, wherein the first surface has a first marking thereon, wherein each spot location of the plurality of spot locations includes a second surface with a second marking thereon, wherein the second surface is in opposition to the first surface, and wherein at least one spot location has the first marking different from the second marking.

8. The basketball game of claim 6, further comprising a timekeeping device, the timekeeping device including a supporting means for attaching the timekeeping device to the support structure.

9. The basketball game of claim 8, wherein the supporting means includes a magnet.

10. The basketball game of claim 6, wherein the first marking on the first surface of each spot location of the plurality of spot locations includes a number ranging from 1 to X, wherein X is equal to the number of spot locations, and wherein the second marking on the second surface of each spot location of the plurality of spot locations includes a number ranging from 1 to Y, wherein Y is a maximum point level used for scoring.

11. The basketball game of claim 6, wherein at least one spot location of the plurality of spot locations is made from a PVC and vinyl material.

12. A method of playing a basketball game, the method comprising:
obtaining a basketball game package having an instruction source and a plurality of spot locations;
providing a playing surface, a support structure mounted on, adjacent to, or above the playing surface, a backboard mounted on the support structure, a hoop mounted on the backboard, and a ball;
disposing the plurality of spot locations on the playing surface;
contacting a spot location of the plurality of spot locations; and
attempting to shoot the ball into the hoop from the spot location of the plurality of spot locations,
wherein each spot location of the plurality of spot locations includes a first surface with a first marking thereon and a second surface with a second marking thereon,
wherein the second surface is in opposition to the first surface, and
wherein at least one spot location has the first marking different from the second marking.

13. The method of playing a basketball game of claim 12, wherein, for each spot location of the plurality of spot locations, the first surface includes a plurality of raised dimples arranged thereon.

14. The method of playing a basketball game of claim 12, wherein the basketball game further utilizes a timekeeping device including a supporting means for attaching the timekeeping device to the support structure.

15. The method of playing a basketball game of claim 12, wherein the basketball game is played by a plurality of players, and wherein each player of the plurality of players attempts to shoot the ball into the hoop from all spot locations of the plurality of spot locations in a predetermined order of advancement before any other players of the plurality of players shoot the ball into the hoop from all spot locations of the plurality of spot locations.

16. The method of playing a basketball game of claim 15, wherein each player of the plurality of players attempts to shoot the ball into the hoop during a turn, and wherein the turn includes one of (a) a predetermined allowable number of attempts, and (b) a lesser of a predetermined maximum number of unsuccessful attempts and a total number of attempts required to successfully shoot the ball into the hoop.

17. The method of playing a basketball game of claim 15, wherein each player of the plurality of players attempts to shoot the ball into the hoop during a turn, and wherein the turn includes a number of successful attempts required to shoot the ball into the hoop that occur before a first unsuccessful attempt to shoot the ball into the hoop, and the first unsuccessful attempt to shoot the ball into the hoop.

18. The method of playing a basketball game of claim 16, wherein if the turn includes the predetermined maximum number of unsuccessful attempts, the player elects, as part of the turn, either (a) to terminate the turn without an additional attempt to shoot the ball into the hoop, or (b) to make an additional attempt to shoot the ball into the hoop from the same spot location from which the player made the first unsuccessful attempt to shoot the ball into the hoop, wherein if the additional attempt is successful, the player is permitted to advance to the next spot location, and wherein if the additional attempt is unsuccessful, the player begins a next turn from a first spot location in the predetermined order of advancement and re-traverses the plurality of spot locations in the predetermined order of advancement.

19. The method of playing a basketball game of claim 17, wherein if the turn includes the number of successful attempts required to shoot the ball into the hoop that occur before the first unsuccessful attempt to shoot the ball into the hoop, and the first unsuccessful attempt to shoot the ball into the hoop, the player elects, as part of the turn, either (a) to terminate the turn without an additional attempt to shoot the ball into the hoop, or (b) to make an additional attempt to shoot the ball into the hoop from the same spot location from which the player made the first unsuccessful attempt to shoot the ball into the hoop, wherein if the additional attempt is successful, the player is permitted to advance to the next spot location, and wherein if the additional attempt is unsuccessful, the player begins a next turn from a first spot location in the predetermined order of advancement and re-traverses the plurality of spot locations in the predetermined order of advancement.

20. The method of playing a basketball game of claim 13, wherein the basketball game is played by at least one player, and wherein each spot location of the plurality of spot locations designates a point level, and wherein spot locations designating high point levels are positioned in areas of the playing surface from which a greater difficulty exists in shooting the ball into the hoop, and wherein total points of each player of the at least one player are determined by adding the point level of each spot location from which the player makes a successful attempt to shoot the ball into the hoop, and wherein each player of the at least one player attempts to accumulate more total points than any other players of the at least one player after a predetermined number of attempts to shoot the ball into the hoop.
